(19) United States
(12) Patent Application Publication
(10) Pub. No.: US 2025/0147789 A1
(43) Pub. Date: May 8, 2025

(54) DEPENDENCY RELATION GRASPING SYSTEM, DEPENDENCY RELATION GRASPING METHOD, AND NON-TRANSITORY COMPUTER-READABLE MEDIUM

(71) Applicant: Hitachi, Ltd., Tokyo (JP)

(72) Inventor: Yumiko OE, Tokyo (JP)

(73) Assignee: Hitachi, Ltd., Tokyo (JP)

(21) Appl. No.: 18/893,208

(22) Filed: Sep. 23, 2024

(30) Foreign Application Priority Data
Nov. 6, 2023 (JP) 2023-189207

(51) Int. Cl. G06F 9/455

(52) U.S. Cl. CPC G06F 9/45558; G06F 2009/45595

(57) ABSTRACT

The present disclosure enables appropriate collection and management of dependency relations regarding booting and/or shutdown of virtual elements and physical elements in a computer system. A dependency relation grasping system collecting and managing information in a computer system that has a plurality of servers and makes up a virtual machine by the plurality of servers, includes a processor. The processor is configured to acquire correlative relation information between a physical element and the virtual machine in the computer system, and identify dependency relations for booting and/or shutdown, between the virtual machine and the physical element, on the basis of the correlative relation information, and store, in a database, relationship information indicating the dependency relation.

### CROSS-REFERENCE TO PRIOR APPLICATION

This application relates to and claims the benefit of priority from Japanese Patent Application No. 2023-189207, filed on Nov. 6, 2023, the entire disclosure of which is incorporated herein by reference.

### BACKGROUND

The present disclosure relates to technology for collecting and managing information in a computer system that has a plurality of physical servers and makes up a virtual machine by one or more of the physical servers.

In computer systems, advance in virtualization technology has led to utilization of software-controlled SDx (SDC (Software Defined Computing), SDN (Software Defined Networking), SDS (Software Defined Storage), and so forth).

Computing systems are becoming increasingly complex, due to the need for software for controlling SDx, in addition to various elements such as business applications, management software, operating systems (OS), hypervisors, hardware, and so forth.

In computer systems, there is a need to perform scheduled power outages, for example, and, in conjunction therewith, there is a need to perform system shutdown and booting. However, there are relationships among elements, and shutdown order and boot order need to be taken into consideration.

However, given the increased complexity of the system, manual control taking into consideration dependency relations among the elements is difficult, and planning and work are time-consuming.

As an example of related art, Japanese Patent Application Publication No. 2014-10772 discloses a technology for extracting, from communication history, communication connection relations among virtual servers, and determining processing order for booting processing or shutdown processing of the virtual servers.

Also, Japanese Patent Application Publication No. 2019-164621 discloses technology for controlling booting of a plurality of communication units using boot priority information for booting the communication units.

### SUMMARY

In the technology disclosed in Japanese Patent Application Publication No. 2014-10772, the processing order among virtual servers when performing booting processing or shutdown processing can be decided, but no consideration is given to the processing order when performing booting processing or shutdown processing for other elements including physical elements such as physical servers and so forth. There is demand for taking physical elements into consideration as well, in a case of implementing booting and shutdown in a computer system.

The present disclosure has been made in light of the foregoing circumstances, and an object thereof is to provide technology that enables appropriate collection and management of dependency relations regarding booting and/or shutdown of virtual elements and physical elements in a computer system.

In order to achieve the above object, a dependency relation grasping system according to an aspect is a dependency relation grasping system collecting and managing information, in a computer system that has a plurality of physical servers and makes up a virtual machine by the plurality of physical servers. The dependency relation grasping system includes a processor. The processor is configured to acquire correlative relation information between a physical element and the virtual machine in the computer system, and identify dependency relations for booting and/or shutdown, between the virtual machine and the physical element, on the basis of the correlative relation information, and store, in a storage unit, relationship information indicating the dependency relation.

According to this aspect, appropriate collection and management of dependency relations regarding booting and/or shutdown of virtual elements and physical elements in a computer system can be performed.

### BRIEF DESCRIPTION OF THE DRAWINGS

FIG. 1 is an overall configuration diagram of a computer system according to an embodiment;

FIG. 2 is a hardware configuration diagram of a dependency relation grasping system according to the embodiment;

FIG. 3 is a configuration diagram of a relationship table according to the embodiment;

FIG. 4 is a configuration diagram of a group configuration table according to the embodiment;

FIG. 5 is a configuration diagram of a management target table according to the embodiment;

FIG. 6 is a flowchart of table creation processing according to the embodiment;

FIG. 7 is a flowchart of relationship table creation (updating) processing according to the embodiment;

FIG. 8 is a flowchart of table updating processing according to the embodiment;

FIG. 9 is a flowchart of boot information output processing according to an embodiment;

FIG. 10 is a diagram illustrating a boot information display screen according to the embodiment;

FIG. 11 is a flowchart of shutdown information output processing according to the embodiment; and

FIG. 12 is a diagram illustrating a shutdown information display screen according to the embodiment.

### DETAILED DESCRIPTION OF THE EMBODIMENT

An embodiment will be described with reference to the drawings. Note that the embodiment described below does not limit the invention according to the claims, and not all elements described in the embodiment or combinations thereof are indispensable as solving means of the invention.

In the following description, information may be described using an expression such as “AAA table”, but information may be expressed by any data structure. That is to say, “AAA table” can be referred to as “AAA information” in order to demonstrate that the information is not dependent on the data structure.

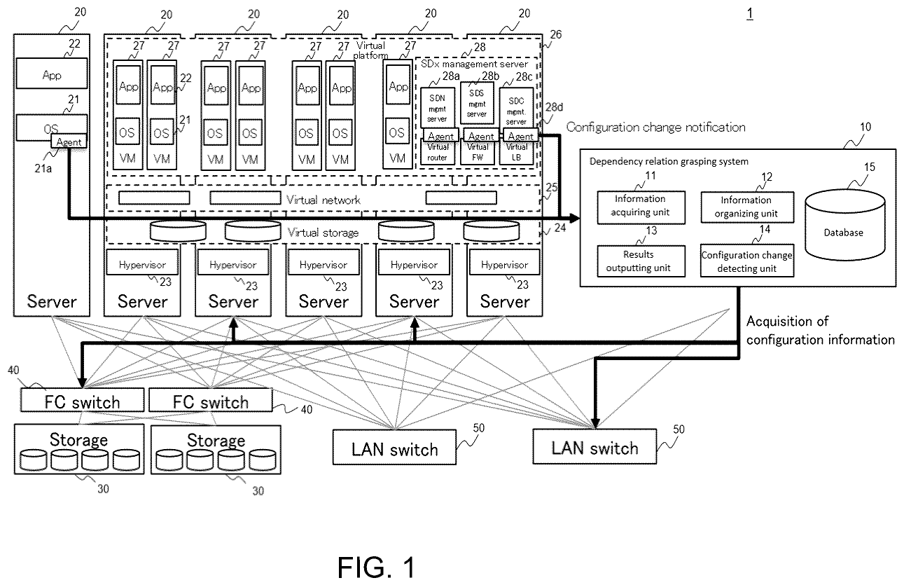

FIG. 1 is an overall configuration diagram of a computer system according to the embodiment.

A computer system 1 includes a dependency relation grasping system 10, one or more servers 20, one or more storages 30, FC (Fibre Channel) switches 40, and LAN switches 50. The one or more servers 20 and the one or more storages 30 are communicably coupled via the FC switch 40. Also, the one or more servers 20 and the dependency relation grasping system 10 are communicably coupled via the LAN switch 50.

The FC switch 40 relays data between the servers 20 and the storages 30. The LAN switch 50 relays data between the servers 20 or between the servers 20 and the dependency relation grasping system 10. The storage 30 is physical storage, and stores various types of data.

The server 20 is physical server, and has processor and memory. There is a server out of the plurality of servers 20 that has an OS (Operating System) 21, and executes an application (App in FIG. 1) 22 on the OS 21. The OS 21 of such a server that performs processing singularly includes an agent 21a that detects change in physical configuration information of the server 20, and notifies the dependency relation grasping system 10 of the change.

Also, there is a server 20 group in the plurality of servers 20 that makes up a virtual storage 24, a virtual network 25, and a virtual platform 26, by virtualization of physical elements of the plurality of servers 20. Such servers 20 each have a hypervisor 23 that creates and runs a virtual machine 27 (VM) on the virtual platform 26. The virtual machine 27 has the OS 21, and executes the application 22 on the OS 21.

The computer system 1 has an SDx management server 28 that manages the virtualization of the server 20 group. The SDx management server 28 may be made up of a VM, for example, or may be made up of a server 20 that is not virtualized. The SDx management server 28 includes, for example, an SDN (Software Defined Networking) management server 28a that manages the virtual network 25, an SDS (Software Defined Storage) management server 28b that manages the virtual storage 24, and an SDC (Software Defined Computing) management server 28c that manages the virtual platform 26. The SDN management server 28a, the SDS management server 28b, and the SDC management server 28c each include an agent 28d that detects changes in configurations that each server manages, and notifies the dependency relation grasping system 10 of the change.

The dependency relation grasping system 10 is a system that performs management and so forth of dependency relations regarding booting and/or shutdown among virtual elements and physical elements in the computer system 1. The dependency relation grasping system 10 includes an information acquiring unit 11, an information organizing unit 12, a results outputting unit 13, a configuration change detecting unit 14, and a database 15.

The information acquiring unit 11 acquires configuration information of physical elements (e.g., information of the configurations of physical elements themselves, information of coupling relations with other physical elements, i.e., correlative relation information) from the physical elements (servers 20, storages 30, FC switch 40, LAN switch 50, and so forth), and acquires configuration information regarding virtual elements (virtual machines) (e.g., information of elements (physical elements, virtual elements) making up the virtual elements or related thereto, i.e., correlative relation information) from the SDx management server 28.

The information organizing unit 12 organizes the configuration information acquired by the information acquiring unit 11, and generates relationship information indicating the dependency relation regarding booting and shutdown among the virtual elements and the physical elements.

The results outputting unit 13 outputs information of elements that are dependent on booting and shutdown regarding desired elements, on the basis of the relationship information.

The configuration change detecting unit 14 receives configuration changes of the elements (physical elements, virtual elements) from the servers 20 and the SDx management server 28, detects whether the configuration changes will affect the dependency relations of booting and shutdown among the elements that are managed, and in a case in which dependency relations will be affected, performs processing to acquire the configuration information.

The database 15 stores a relationship table 16 that manages information of dependency regarding booting and shutdown among the elements, a group configuration table 17 that manages information relating to configurations of groups (host group made up of a plurality of the physical servers, virtual network made up of the plurality of physical servers, virtual storage made up of the plurality of physical servers, and so forth), and a management target table 18 that manages targets of which dependency relations of booting and shutdown are managed by the dependency relation grasping system 10.

Next, a hardware configuration of the dependency relation grasping system 10 will be described.

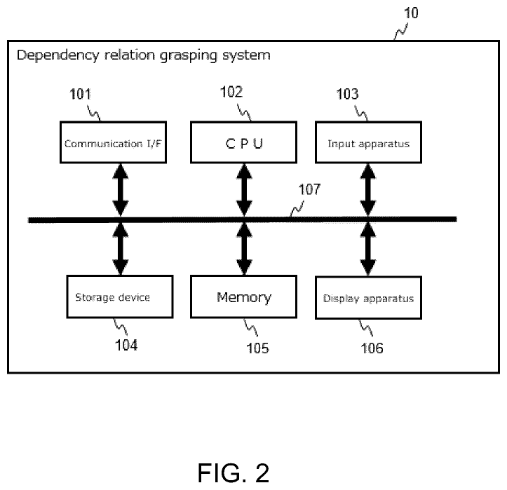

FIG. 2 is a hardware configuration diagram of the dependency relation grasping system according to the embodiment.

The dependency relation grasping system 10 is made up of a computer such as, for example, a PC (Personal Computer), a general-purpose server, or the like, and includes a communication interface (I/F) 101, a CPU 102 as an example of a processor, an input apparatus 103, a storage device 104, memory 105, and a display apparatus 106, and these components are communicably coupled via a bus 107.

The communication I/F 101 is an interface such as, for example, a wired LAN card, wireless LAN card, or the like, and communicates with other apparatuses (e.g., server 20) via a network.

The CPU 102 executes various types of processing according to programs (dependency relation grasping program) stored in the memory 105 and/or the storage device 104. The information acquiring unit 11, the information organizing unit 12, the results outputting unit 13, and the configuration change detecting unit 14 are configured by the CPU 102 executing the dependency relation grasping program.

The memory 105 is RAM, for example, and stores programs executed by the CPU 102 and necessary information.

The storage device 104 is an example of a storage unit, such as a hard disk, flash memory, or the like, for example, and stores programs executed by the CPU 102 and data used by the CPU 102. The storage device 104 stores the dependency relation grasping program that executes various types of processing of the dependency relation grasping system 10 as a program, and stores the database 15.

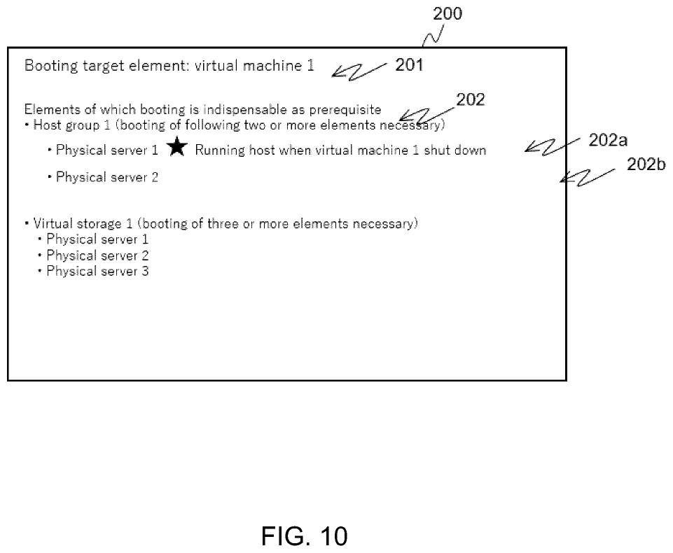

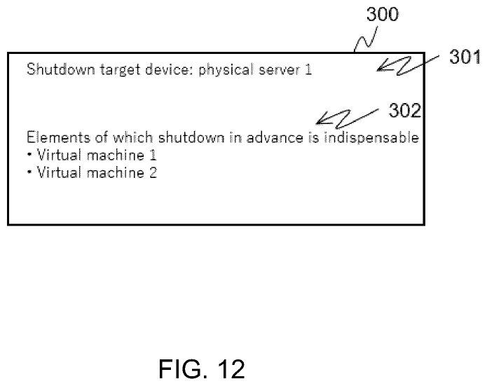

The input apparatus 103 is a mouse, keyboard, or the like, for example, and accepts input of information by a user. The display apparatus 106 is a display, for example, and performs display output of screens including various types of information (e.g., a boot information display screen 200 (see FIG. 10), a shutdown information display screen 300 (see FIG. 12)).

Next, the relationship table 16 will be described in detail.

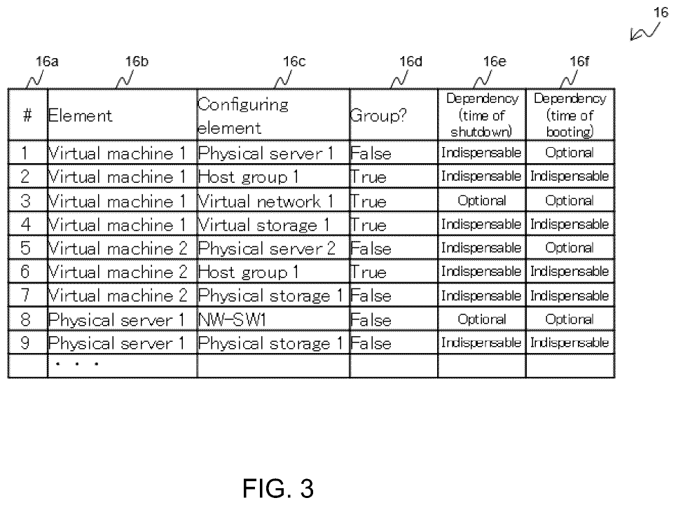

FIG. 3 is a configuration diagram of the relationship table according to the embodiment.

The relationship table 16 is a table that manages certain element (virtual element, physical element), and dependency of booting and shutdown between the element and an element making up the element or related to the element (referred to as configuring element). A record in the relationship table 16 includes fields of number (#) 16a, element 16b, configuring element 16c, group? 16d, dependency (time of shutdown) 16e, and dependency (time of booting) 16f.

The number of the record is stored in the number (#) 16a. Identification information (name, etc.) of the element that is the target of the record is stored in the element 16b. Identification information of an element that makes up an element corresponding to the record, or an element related thereto (referred to as configuring element), is stored in the configuring element 16c. Information indicating whether or not the configuring element corresponding to the record is a group, i.e., whether or not the configuring element is made up of a plurality of elements, is stored in the group? 16d. In the present embodiment, in a case in which the configuring element corresponding to the record is a group, True is stored, and in a case of not being a group, False is stored.

Information indicating the dependency that the configuring element corresponding to the record depends on the element at the time of shutdown is stored in the dependency (time of shutdown) 16e. In the present embodiment, indispensable is stored as the dependency in a case in which shutdown of the element is indispensable at the time of shutdown, and optional is stored in a case in which shutdown of the element is not indispensable. Information indicating the dependency that the configuring element corresponding to the record depends on the configuring element at the time of booting is stored in the dependency (time of booting) 16f. In the present embodiment, indispensable is stored as the dependency in a case in which booting of the configuring element is indispensable at the time of booting, and optional is stored in a case in which booting of the configuring element is not indispensable.

Next, the group configuration table 17 will be described in detail.

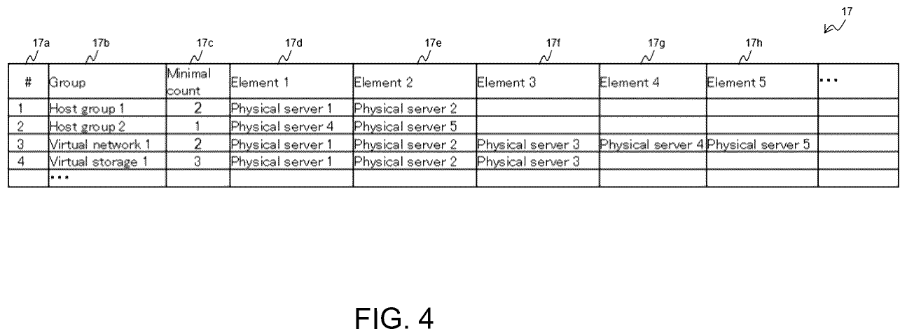

FIG. 4 is a configuration diagram of the group configuration table according to the embodiment.

The group configuration table 17 is a table that manages configurations of groups, and has a record for each group. The record in the group configuration table 17 includes fields of number (#) 17a, group 17b, minimum count 17c, and a plurality of elements (element 1 17d, element 2 17e, element 3 17f, element 4 17g, element 5 17h, and so forth).

The number of the record is stored in the number (#) 17a. The group name of the group corresponding to the record is stored in the group 17b. A minimally-necessary count of elements (minimum count) to operate as a group corresponding to the record is stored in the minimum count 17c. Identification information of elements (physical elements) making up the group is stored in the plurality of elements (element 1 17d, element 2 17e, element 3 17f, element 4 17g, element 5 17h, and so forth). Note that relationship information corresponds to the relationship table 16 and the group configuration table 17.

Next, the management target table 18 will be described.

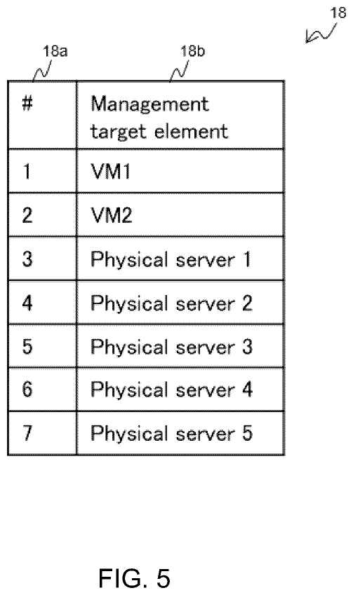

FIG. 5 is a configuration diagram of the management target table according to the embodiment.

The management target table 18 is a table that manages elements that are the target of managing booting and shutdown by the dependency relation system grasping 10 (management target elements), and stores a record for each management target element. The record of the management target table 18 includes fields of number (#) 18a and management target element 18b. The number of the record is stored in the number (#) 18a. Identification information of the management target element corresponding to the record is stored in the management target element 18b. Examples of management target elements include virtual machines (management target virtual machines), servers (physical servers), and so forth.

Next, processing operations of the dependency relation grasping system 10 will be described.

First, table creation processing that the dependency relation grasping system 10 executes the first time of starting operations will be described.

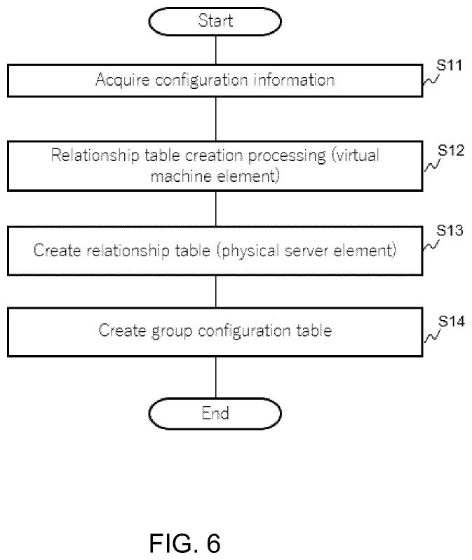

FIG. 6 is a flowchart of the table creation processing according to the embodiment.

First, the information acquiring unit 11 acquires configuration information of physical elements (e.g., information of the configurations of physical elements themselves, information of coupling relations with other physical elements) from the physical elements (servers 20, storages 30, FC switch 40, LAN switch 50, and so forth), and acquires configuration information regarding virtual elements (virtual machines, etc.) (e.g., information of physical elements making up the virtual elements or related thereto) from the SDx management server 28 (S11). Configuration information regarding virtual elements includes information such as, for example, a network to which the virtual machine is coupled, a disk that is coupled, a system disk of the virtual machine, and so forth.

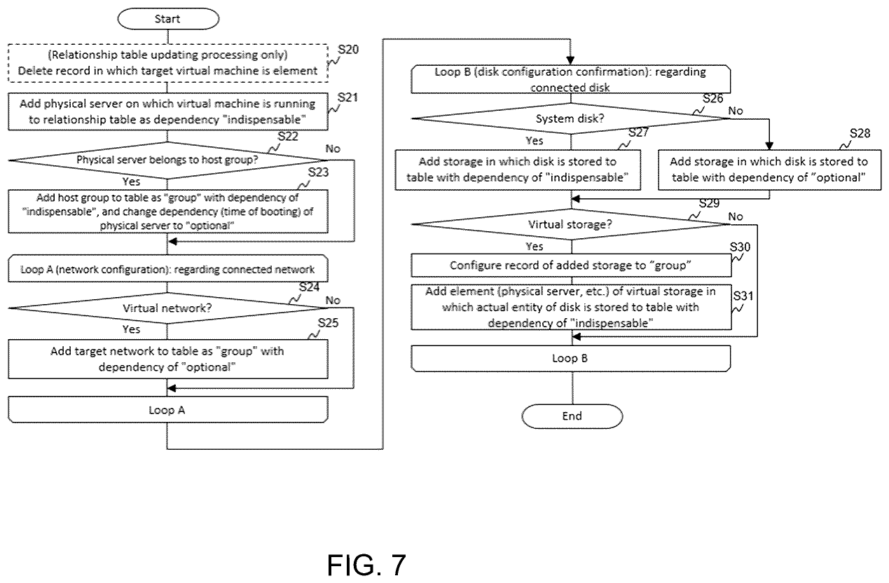

Next, the information organizing unit 12 executes relationship table creation processing (virtual machine element) (see FIG. 7) for creating records relating to virtual machines in the relationship table 16, on the basis of the configuration information regarding the virtual elements (S12). According to this relationship table creation processing (virtual machine element) (see FIG. 7), records relating to virtual machines in the relationship table 16 (e.g., records of which the number of the number 16a are 1 to 7 in FIG. 3) are created.

Next, the information organizing unit 12 creates records relating to physical servers in the relationship table 16, on the basis of the configuration information regarding the physical elements (S13). According to this step, records relating to physical servers in the relationship table 16 (e.g., records of which the number of the number 16a are 8 and 9 in FIG. 3) are created.

Next, with regard to groups registered as configuring elements in the relationship table 16, the information organizing unit 12 extracts configuring elements of the groups and minimally-necessary element counts for the groups, on the basis of configuration information regarding the virtual machines acquired from the SDx management server 28, creates the group configuration table 17 (S14) on the basis of the extracted information, and ends the table creation processing.

According to this table creation processing, the relationship table 16 and the group configuration table 17 in an initial state of the computer system 1 are created.

Next, the relationship table creation processing (virtual machine element) in step S12 will be described in detail.

FIG. 7 is a flowchart of the relationship table creation (updating) processing according to the embodiment. The relationship table creation processing (virtual machine element) is processing of steps S21 to S31 in FIG. 7.

First, for a record regarding a physical server on which a virtual machine runs, i.e., the physical server making up the virtual machine (target physical server), the information organizing unit 12 adds a record to the relationship table 16 in which the virtual machine is the element, the physical server is the configuring element, the configuring element is not a group (False), and the dependency (time of shutdown) and dependency (time of booting) are set to “indispensable” (S21).

Next, the information organizing unit 12 determines whether or not the target physical server belongs to a host group on the basis of the configuration information acquired from the SDx management server 28 (S22).

In a case in which determination is made as a result thereof that the target physical server belongs to the host group (Yes in S22), the information organizing unit 12 adds, as a record for the host group, a record to the relationship table 16 in which the virtual machine is the element, the host group is the configuring element, the configuring element is a group (True), and the dependency (time of shutdown) and the dependency (time of booting) are set to “indispensable”, changes the dependency (time of booting) of the target physical server in the record to “optional” (S23), and advances to processing of loop A (S24 to S25). The reason of changing the dependency (time of booting) of the target physical server to “optional” here is because the virtual machine may be configured at a separate physical server from the target physical server belonging to the host group, and is not limited to the target physical server.

Conversely, in a case in which determination is made that the target physical server does not belong to the host group (No in S22), the information organizing unit 12 advances the processing to the processing of loop A (S24 to S25).

Next, the information organizing unit 12 executes the processing of loop A (S24 to S25) with each of all networks coupled to the virtual machine as a processing target. A network that is a processing target will be referred to as “target network” here.

In the processing of loop A, the information organizing unit 12 determines whether or not the target network is a virtual network (S24).

In a case in which the target network is determined to be a virtual network (Yes in S24) as a result thereof, the information organizing unit 12 adds a record to the relationship table 16 as a record regarding the target network, in which the virtual machine is the element, the target network is the configuring element, the configuring element is a group (True), and the dependency (time of shutdown) and dependency (time of booting) are set to “optional” (S25), and the processing of loop A with respect to the target network ends.

Conversely, in a case in which the target network is determined not to be a virtual network (No in S24), the information organizing unit 12 ends the processing of loop A with respect to the target network.

In a case in which the processing of loop A with respect to the target network ends, the information organizing unit 12 executes the processing of loop A with the next network as the target network, and in a case in which the processing of loop A has ended for all networks that are coupled, the processing exits loop A.

Next, the information organizing unit 12 executes processing of loop B (S26 to S31) with each of all disks connected to the virtual machine as processing targets. A disk that is a processing target will be referred to as “target disk” here.

In the processing of loop B, the information organizing unit 12 determines whether or not the target disk is a system disk (S26).

In a case in which the target disk is determined to be a system disk (Yes in S26) as a result thereof, the information organizing unit 12 adds a record to the relationship table 16 as a record regarding the storage in which the disk is stored, in which the virtual machine is the element, the storage in which the target disk is stored is the configuring element, and the dependency (time of shutdown) and dependency (time of booting) are set to “indispensable” (S27), and the processing advances to step S29.

Conversely, in a case in which the target disk is determined not to be a system disk (No in S26), the information organizing unit 12 adds a record to the relationship table 16 as a record regarding the storage in which the disk is stored, in which the virtual machine is the element, the storage in which the target disk is stored is the configuring element, and the dependency (time of shutdown) and dependency (time of booting) are set to “optional” (S28), and the processing advances to step S29.

In step S29, the information organizing unit 12 determines whether or not the target disk is a virtual storage.

In a case in which the target disk is determined to be a virtual storage (Yes in S29) as a result thereof, the information organizing unit 12 configures the record, regarding the storage in which the disk is stored, to a group (True) (S30), adds a record to the relationship table 16 as a record regarding the element of an actual entity (e.g., physical server) of the virtual storage in which an actual entity of the target disk is stored, in which the element that is the actual entity is the element, the configuring element of the element that is the actual entity (e.g., physical storage) is the configuring element, and the dependency (time of shutdown) and the dependency (time of booting) are set to “indispensable” (S31), and the processing of loop B with respect to the target disk ends.

Conversely, in a case in which the target disk is determined not to be a virtual storage (No in S29), the information organizing unit 12 ends processing of loop B with respect to the target disk.

In a case in which the processing of loop B with respect to the target disk ends, the information organizing unit 12 executes the processing of loop B with the next disk as the target disk, and in a case in which the processing of loop B has ended for all disks that are coupled, the flow exits loop B, and ends the relationship table creation processing (virtual machine element).

Next, table updating processing by the dependency relation grasping system 10 will be described.

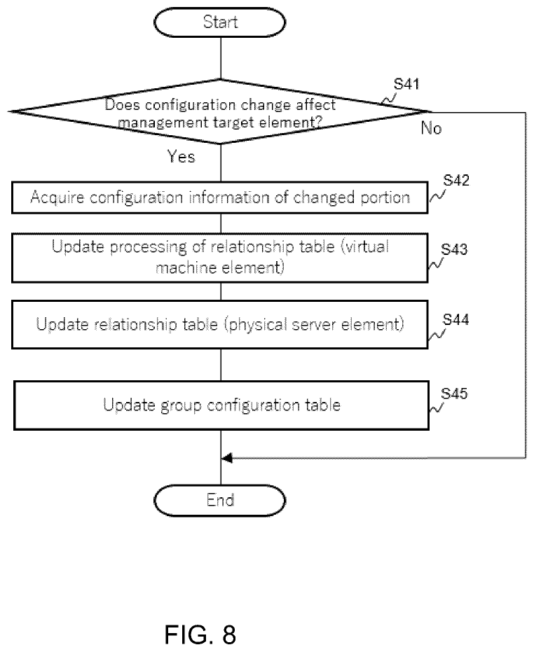

FIG. 8 is a flowchart of table updating processing according to the embodiment.

The table updating processing is executed in a case in which a change notification regarding configuration has been received from the agent 28d of the SDx management server 28, for example. Note that in a case in which work is performed in the computer system 1 such as work in which, for example, the host (server) on which the virtual machine is running is changed, a disk is added to the virtual machine, the network of the virtual machine is changed, and so forth, the agent 28d notifies the dependency relation grasping system 10 of the contents of this change.

The configuration change detecting unit 14 of the dependency relation grasping system 10 references the management target table 18 and determines whether or not the notified configuration change affects the management target elements (S41).

In a case in which determination is made as a result thereof that the configuration change does not affect the management target elements (No in S41), the configuration change detecting unit 14 ends the table updating processing, since this means that there is no need to update the table.

Conversely, in a case in which determination is made that the configuration change affects the management target elements (Yes in S41), the configuration change detecting unit 14 notifies the information acquiring unit 11 of the changed portion, and the information acquiring unit 11 that has received the notification acquires configuration information of the changes from the SDx management server 28 (S42).

Next, the information organizing unit 12 executes relationship table updating processing (virtual machine element) (see FIG. 7) for updating the relationship table 16, on the basis of the configuration information regarding the changed portion (S43).

Next, the information organizing unit 12 updates information relating to physical servers in the relationship table 16, on the basis of the configuration information regarding the changed portion (S44).

Next, on the basis of the update information of the changed portion acquired from the SDx management server 28, the information organizing unit 12 extracts, with regard to elements of a group that are updated in the relationship table 16, the configuring elements of the group and the count of elements that are minimally necessary for the group, updates the group configuration table 17 (S45), and ends the table updating processing.

According to this table updating processing, in a case in which configuration information is changed regarding management target elements in the computer system 1, the relationship table 16 and the group configuration table 17 can be appropriately updated by following the contents of the change.

Next, the relationship table updating processing (virtual machine element) of step S43 will be described in detail.

The relationship table updating processing (virtual machine element) is the processing of steps S20 to S31 in FIG. 7.

First, the information organizing unit 12 deletes, from the relationship table 16, records in which virtual machines that are the target of configuration change are elements (S20). Note that subsequent processing is the same processing as the relationship table creation processing.

Next, description will be made regarding boot information output processing, in which information of other elements that need to be booted is output at the time of booting an element that is a boot target.

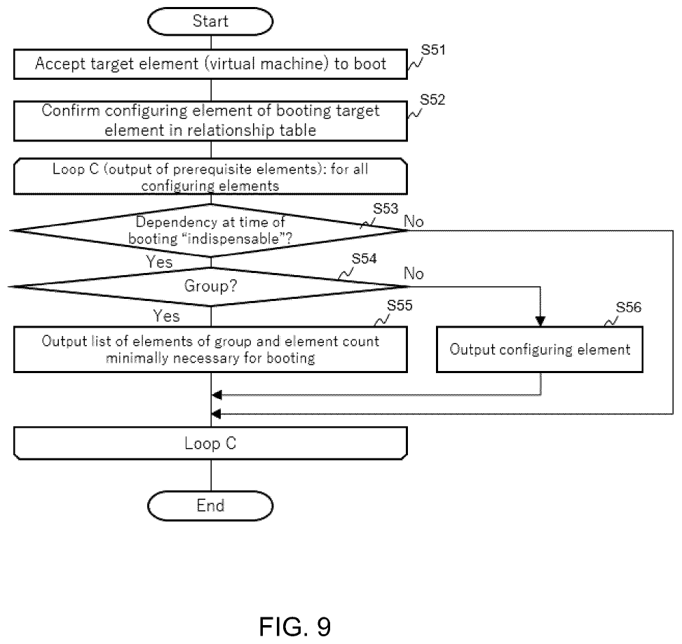

FIG. 9 is a flowchart of the boot information output processing according to the embodiment.

The results outputting unit 13 accepts specification from the user regarding an element that is a target for booting (boot target element, e.g., virtual machine in this example) (S51), the results outputting unit 13 then references the relationship table 16, and confirms a configuring element that corresponds to the boot target element (S52).

Next, the results outputting unit 13 executes processing of loop C (S53 to S56) with each configuring element that is confirmed as a processing target. A configuring element that is a processing target will be referred to as “target configuring element” here.

In the processing of loop C, the results outputting unit 13 first references the record of the target configuring element in the relationship table 16, and determines whether or not the dependency at the time of booting of the target configuring element is “indispensable” (S53).

In a case in which determination is made as a result thereof that the dependency at the time of booting of the target configuring element is “indispensable” (Yes in S53), the results outputting unit 13 determines whether or not the target configuring element is a group (S54).

In a case in which determination is made as a result thereof that the target configuring element is a group (Yes in S54), the results outputting unit 13 outputs (S55), to the boot information display screen 200 (see FIG. 10), a list of the elements belonging to the group, the element count that is minimally necessary for booting this group, elements which were running on the boot target element at the time of shutdown (configuring elements associated in the relationship table 16 with the boot target element in the group), and ends the processing of loop C regarding the target configuring element. Conversely, in a case in which determination is made that the target configuring element is not a group (No in S54), the results outputting unit 13 outputs (S56), to the boot information display screen 200, the target configuring element, and ends the processing of loop C regarding the target configuring element.

Meanwhile, in a case in which the dependency at the time of booting of the target configuring element is not “indispensable” (No in S53), the results outputting unit 13 ends the processing of loop C regarding the target configuring element.

In a case in which the processing of loop C regarding the target configuring element ends, the results outputting unit 13 executes the processing of loop C with the next configuring element as the target configuring element, and in a case in which the processing of loop C has ended for all target configuring elements that are confirmed, the flow exits loop C, and ends the boot information output processing.

Next, the boot information display screen 200 will be described.

FIG. 10 is a diagram illustrating the boot information display screen according to the embodiment. The boot information display screen 200 in FIG. 10 is an example of the boot information display screen in a case in which virtual machine 1 has been input as a boot target element in a case in which the relationship table 16 is in the state shown in FIG. 3, and the group configuration table 17 is in the state shown in FIG. 4.

The boot information display screen 200 includes a boot target element display area 201 that displays the boot target elements, and a boot-indispensable element display area 202 that displays elements regarding which booting a is indispensable as prerequisite.

In the boot-indispensable element display area 202, configuring elements regarding which booting is necessary is displayed, and in a case in which the configuring element is a group, a list of elements belonging to that group is displayed. In the example in FIG. 10, a list of elements belonging to host group 1, which is necessary for booting of the virtual machine 1, and a list of elements belonging to virtual storage 1, are displayed. Also, an element count 202a of elements minimally necessary for booting of the group (e.g., count of physical servers) is displayed in the boot-indispensable element display area 202. Also, shutdown-time element information 202b by which elements out of the group, making up the boot target element when the shutdown was executed (e.g., server in a case in which the boot target element is a virtual machine), can be identified, is displayed in the boot-indispensable element display area 202. According to this shutdown-time element information 202b, elements that were making up the boot target elements when the shutdown was executed can be identified. Hence, running can be performed in the same state as the time when the shutdown was executed, and accordingly imbalanced use of resources and so forth can be appropriately prevented.

Next, shutdown information output processing, in which information is output regarding other elements that need shutdown at the time of shutdown of an element that is a shutdown target, will be described.

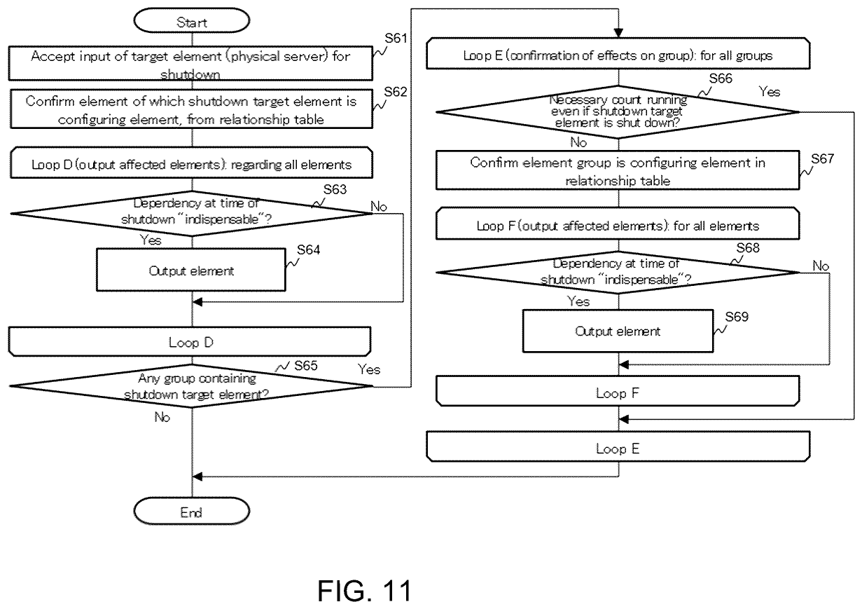

FIG. 11 is a flowchart of shutdown information output processing according to the embodiment.

The results outputting unit 13 receives from the user, specification regarding an element that is a target for shutdown (shutdown target element, e.g., physical server in this example) (S61), and then the results outputting unit 13 references the relationship table 16, and confirms an element of which a shutdown target element is the configuring element (S62).

Next, the results outputting unit 13 executes processing of loop D (S63 to S64) with each element that is confirmed as a processing target. An element that is a processing target will be referred to as “target element” here.

In the processing of loop D, the results outputting unit 13 references the record of the target element in the relationship table 16, and determines whether or not the dependency at the time of shutdown is “indispensable” for the target element (S63).

In a case in which determination is made as a result thereof that the dependency at the time of shutdown is “indispensable” for the target element (Yes in S63), the results outputting unit 13 outputs (S64) this element as an element regarding which shutdown is indispensable to the shutdown information display screen 300 (see FIG. 12), and ends the processing of loop D regarding the target element.

Conversely, in a case in which the dependency of the target element at the time of shutdown is not “indispensable” (No in S63), the results outputting unit 13 ends the processing of loop D regarding the target element.

In a case in which the processing of loop D regarding the target element ends, the results outputting unit 13 executes the processing of loop D with the next element as the target element, and in a case in which the processing of loop D has ended for all target elements that are confirmed, the flow exits loop D.

Next, the results outputting unit 13 determines whether or not there is a group including the shutdown target element (S65).

In a case in which determination is made as a result thereof that there is no group including the shutdown target element (No in S65), the results outputting unit 13 ends the shutdown information output processing.

Conversely, in a case in which there is a group including the shutdown target element (Yes in S65), the results outputting unit 13 executes processing of loop E (S66 to S69) with each group including the shutdown target element as a processing target. A group that is a processing target will be referred to as “target group” here.

In the processing of loop E, the results outputting unit 13 determines whether or not the minimally necessary count of elements will be running in the target group even though the shutdown target element is shut down (S66).

In a case in which determination is made as a result thereof that the minimally necessary count of elements will not be running (No in S66), the results outputting unit 13 confirms elements in the relationship table 16 regarding which the group is a configuring element (S67).

Next, the results outputting unit 13 executes processing of loop F (S68 to S69) with each element that is confirmed as a processing target.

In the processing of loop F, the results outputting unit 13 determines whether or not the dependency at the time of shutdown is “indispensable” for the element that is the processing target (S68).

In a case in which determination is made as a result thereof that the dependency at the time of shutdown is “indispensable” for the element that is the processing target (Yes in S68), the results outputting unit 13 outputs (S69) that shutdown of this element that is the processing target is indispensable to the shutdown information display screen 300 (see FIG. 12), and ends the processing of loop F regarding the element that is the processing target.

Conversely, in a case in which determination is made that the dependency at the time of shutdown of the element that is the processing target is not “indispensable” (No in S68), the results outputting unit 13 ends the processing of loop F regarding the element that is the processing target.

In a case in which the processing of loop F regarding the element that is the processing target ends, the results outputting unit 13 executes the processing of loop F with the next element as the processing target, and in a case in which the processing of loop F has ended for all elements that are confirmed, the flow exits loop F.

Meanwhile, in a case of determining that the minimally necessary count of elements will be running (Yes in S66), the results outputting unit 13 exits the processing of loop F.

After loop F, the results outputting unit 13 executes the processing of loop E with the next group as the target group, and in a case in which the processing of loop E has ended for all groups that are confirmed, the flow exits loop E, and the shutdown information output processing ends.

Next, the shutdown information display screen 300 will be described.

FIG. 12 is a diagram illustrating the shutdown information display screen according to the embodiment. The shutdown information display screen 300 in FIG. 12 is an example of the shutdown information display screen in a case in which physical server 1 has been input as the shutdown target element in a case in which the relationship table 16 is in the state shown in FIG. 3, and the group configuration table 17 is in the state shown in FIG. 4.

The shutdown information display screen 300 includes a shutdown target element display area 301 that displays shutdown target elements, and a shutdown-indispensable element display area 302 that displays elements regarding which shutdown in advance is indispensable. In the example in FIG. 12, virtual machine 1 and virtual machine 2 are displayed in the shutdown-indispensable element display area 302. In this example, virtual machine 1 is output (displayed) in the shutdown-indispensable element display area 302 by the processing of step S64, and virtual machine 2 is output in the shutdown-indispensable element display area 302 by the processing of step S69. According to this shutdown information display screen, virtual machines regarding which shutdown is indispensable at the time of shutdown of the physical server can be appropriately displayed.

Note that the present invention is not limited to the above-described embodiment, and can be carried out modified variously without departing from the spirit of the present invention.

For example, description is made in the above embodiment that dependency relations for shutdown and booting are managed, but the present invention is not limited to this, and dependency relations for one or the other of shutdown and booting may be managed.

Also, while only elements indispensable for booting a booting target element are displayed in the above embodiment, the present invention is not limited to this, and may also display elements related to the booting target element (any element). Also, while only elements indispensable for shutdown of a shutdown target element are displayed in the above embodiment, the present invention is not limited to this, and may also display elements related to the shutdown target element (any element).

Also, in the above embodiment, part or all of processing performed by processors may be performed by hardware circuits. Also, the program in the above embodiment may be installed from a program source. The program source may be a program distribution server or recording medium (e.g., portable recording medium).

What is claimed is:

1. A dependency relation grasping system collecting and managing information in a computer system that has a plurality of physical servers and makes up a virtual machine by the plurality of physical servers,
the dependency relation grasping system comprising a processor, wherein
the processor is configured to
acquire correlative relation information between a physical element and the virtual machine in the computer system, and
identify dependency relations for booting and/or shutdown, between the virtual machine and the physical element, on the basis of the correlative relation information, and store, in a storage unit, relationship information indicating the dependency relation.

2. The dependency relation grasping system according to claim 1, wherein
the virtual machine can be made up of any physical server out of a plurality of physical servers that make up a host group, and
the processor is configured to
acquire host group configuration information indicating the plurality of physical servers making up the host group,
identify the host group to which the physical server making up the virtual machine belongs, on the basis of the host group configuration information, identify a dependency relation for booting and/or shutdown between the virtual machine and the host group, and include identified dependency relation in the relationship information and store the thereof in the storage unit, and
store the host group configuration information in the storage unit.

3. The dependency relation grasping system according to claim 2, wherein
the host group configuration information includes a count of the physical servers that is minimally necessary for making up the host group.

4. The dependency relation grasping system according to claim 2, wherein
the dependency relation includes a dependency relation for booting, and
the processor is configured to, in a case in which the physical server making up the virtual machine belongs to the host group,
configures a dependency relation between the virtual machine and the physical server for booting to optional, and configure a dependency relation between the virtual machine and the host group for booting to indispensable.

5. The dependency relation grasping system according to claim 1, wherein
the processor is configured to
also include, in the relationship information a dependency relation for booting and/or shutdown regarding an element and/or group of elements relating to the virtual machine, and store thereof in the storage unit, wherein the dependency relation including information regarding whether the element and/or the group of elements is indispensable or optional for booting and/or shutdown of the virtual machine.

6. The dependency relation grasping system according to claim 1, wherein
the processor is configured to
accept a notification that a configuration relating to a virtual machine is changed,
determine whether or not the change that has been notified is a change relating to a management target virtual machine, which is a virtual machine that is a management target,
acquire, in a case in which the change relates to the management target virtual machine, new correlative relation information between the management target virtual machine and a physical element in the computer system, and
update the relationship information on the basis of the new correlative relation information.

7. The dependency relation grasping system according to claim 2, wherein
the processor is configured to
accept an instruction of a virtual machine that is a booting target, and
identify a physical server and/or host group necessary for booting of the virtual machine that is the booting target on the basis of the relationship information, and output information indicating the physical server and/or the host group that has been identified.

8. The dependency relation grasping system according to claim 7, wherein
the processor is configured to
display information indicating a physical server count that is minimally necessary in the host group necessary for the booting.

9. The dependency relation grasping system according to claim 8, wherein
the processor is configured to
display information that enables identifying of a physical server making up the virtual machine at a time of shutdown at a preceding time in the host group necessary for the booting.

10. The dependency relation grasping system according to claim 2, wherein
the processor is configured to
accept an instruction of a physical server that is a shutdown target, and
identify a virtual machine necessary for shutdown of the physical server that is the shutdown target on the basis of the relationship information, and output information indicating the virtual machine that has been identified.

11. A dependency relation grasping method performed by dependency relation grasping system collecting and managing information in a computer system that has a plurality of physical servers and makes up a virtual machine by the plurality of physical servers, the dependency relation grasping method comprising:
acquiring correlative relation information between a physical element and the virtual machine in the computer system; and
identifying dependency relations for booting and/or shutdown, between the virtual machine and the physical element, on the basis of the correlative relation information, and storing, in a storage unit, relationship information indicating the dependency relation.

12. A non-transitory computer-readable medium storing a dependency relation grasping program causing a computer to execute processing for managing, in a computer system that has a plurality of physical servers, a dependency relation for booting and/or shutdown, between a physical element and a virtual machine made up of the plurality of physical servers,
the dependency relation grasping program causing the computer to:
acquire correlative relation information between a physical element system and the virtual machine in the computer; and
identify dependency relations for booting and/or shutdown, between the virtual machine and the physical element, on the basis of the correlative relation information, and store, in a storage unit, relationship information indicating the dependency relation.
